(19) United States
(12) Patent Application Publication
(10) Pub. No.: US 2007/0214977 A1
(43) Pub. Date: Sep. 20, 2007

(54) Color filter printing method, color filter printing apparatus, and color filter substrate

(75) Inventor: Mamoru Okamoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC LCD Technologies, Ltd., Kanagawa (JP)

(21) Appl. No.: 11/723,319

(22) Filed: Mar. 19, 2007

(30) Foreign Application Priority Data
Mar. 20, 2006 (JP) 2006-076985

(51) Int. Cl. B41M 1/10

(52) U.S. Cl. 101/170

(57) ABSTRACT

A gravure printing plate is arranged on a stage, and recessions formed in the gravure printing plate are filled with photosensitive ink. The ink fills the recessions by being placed on an end of the gravure printing plate and being wiped with a blade. The gravure printing plate is then heated while the gravure printing plate is irradiated with UV light from the bottom side of the stage, thereby curing the lower stratum of the ink in the recessions. A blanket is then pressed against the gravure printing plate, and rotated to accept the ink filling the recessions. The ink accepted onto the blanket is then transferred to a transparent substrate, effecting printing of the color filter. It is accordingly possible to print a color filter having a color filter layer with a highly accurate pattern configuration, without any contaminant matter being transferred to the color filter layer.

### BACKGROUND OF THE INVENTION

1. Field of the Invention

The present invention relates to a method for printing a color filter onto a substrate, and relates in particular to a color filter printing method adapted to intricate patterns such as those of liquid crystal color filters, to a color filter printing apparatus, and to a color filter substrate.

2. Description of the Related Art

Color liquid crystal displays are lightweight, have a thin profile, and consume little power, for which reason they have drawn attention as display units for replacing the CRTs (cathode ray tubes) used in the past for PC monitors, TVs (televisions), and the like. Recently, there has been a step up in intensity of efforts to develop technology for increasing display size and reducing cost of LCDs. In particular, technologies for reducing costs are crucial in terms of achieving general acceptance of color liquid crystal displays. A novel method of manufacturing color filters has been proposed as one such cost reduction technology.

The principal method to date has been the so-called pigment dispersion process, in which a total of four colors, namely black, R (Red), G (Green), and B (Blue), are formed by photolithography on a glass substrate; however, drawbacks of photolithography processes include the high cost of equipment needed for coating, exposure, development, and so on, as well as low utilization efficiency of the principal materials of black RGB. Consequently, ink-jet processes and printing processes have been proposed as color filter production methods which can replace the pigment dispersion process.

Ink-jet processes have the advantage that alignment of the various color filter patterns can be accomplished through program control; on the other hand, susceptibility to nozzle clogging and slow processing speed are potential issues in terms of mass production. Meanwhile, printing processes are already in use for certain products, and show promise as replacement processes for the pigment dispersion process.

Depending on the type of printing plate used or difference in the printing mechanism, printing processes are classified as gravure printing, anastatic printing, planographic printing, reverse printing, and so on; however, in consideration of throughput and the pattern dimensions required for color filters, gravure printing is perhaps best adapted as a color filter production process.

By way of illustration, a color filter production process employing a conventional gravure printing process will be described in detail. FIGS. 1A to 1D are outline diagrams illustrating the manufacturing flow of a conventional color filter substrate, wherein FIG. 1A is a sectional view of a gravure printing plate, FIG. 1B is a sectional view of the gravure printing plate filled with colored ink, FIG. 1C is a sectional view after the blanket has received the colored ink, and FIG. 1D is a sectional view after transfer of the colored ink to the transparent substrate. First, as depicted in FIG. 1A, a gravure printing plate 116 having recessions 115 formed thereon is positioned on a stage 107. The depth of the recessions 115 is about 8 μm, for example. Next, as depicted in FIG. 1B, ink 106 is placed on the edge of the gravure printing plate 116, and a blade 104 is pressed against the gravure printing plate 116 and swept thereover so as to wipe it, thereby filling the recessions 115 with the ink 106. Subsequently, as depicted in FIG. 1C, a blanket 109 is pressed against the gravure printing plate 116 and turned, whereby the ink 106 filling the recessions 115 is accepted onto the blanket 109. The ink 118 is accepted onto the surface of the blanket 109, with some remaining ink 117 left in the recessions 115. In consideration of the fact that the ink becomes split when the ink is accepted onto the blanket 109, the depth of the recessions 115 is designed so as to make allowance for the ink left at the bottom of the recessions 115. Where the depth of the recessions 115 is about 8 μm, the ink accepted onto the blanket 109 will be about 2 μm thick, while the remaining ink 117 left in the recessions 115 will be about 6 μm deep. Next, as depicted in FIG. 1D, a transparent substrate 101 is placed on the stage 107, and the ink 118 that has been picked up on the blanket 109 is transferred to the transparent substrate 101. The above operation is repeated three times to produce an RGB 3-color filter.

In this sort of color filter production process employing a conventional gravure printing process, when the RGB ink which fills the recessions of the gravure printing plate is picked up onto the blanket, only a portion of the ink is picked up while the remainder is left in the recessions as remaining ink. Thus, the color filter layer formed by this sort of printing process may lack an edge or have another variability in the shape of the pattern, or unevenness of the pattern surface.

Patent document 1 (Japanese Laid-Open Patent Application No. 8-94822) proposes a technique for countering the issue regarding splitting of the ink within the recessions of the gravure printing plate. Using a silicone rubber with outstanding ink release properties, the surface of the blanket is provided with recessions, imparting the blanket itself with printing plate functionality, which serves to prevent splitting of the ink within the recessions.

The precision printing method disclosed in patent document 2 (Japanese Laid-Open Patent Application No. 6-47895) includes a step in which, the patterned ink formed on the gravure printing plate is irradiated with UV (ultraviolet) light prior to being transferred to the blanket, so that the ink will be partially set. The technology disclosed therein is intended to transfer the ink on the gravure printing plate onto the blanket, without the ink splitting, and afford a printed pattern of uniform film thickness and good edge shape. An anaerobic UV-setting ink is used as the ink. However, in the embodiments it is also taught that the ink can be transformed into a partially set state and transferred completely onto the blanket when a glass plate is used as the gravure printing plate, the recessions are filled with regular ink that is not anaerobic, and the ink is partially set by irradiation with UV from the back side of the glass plate.

Patent document 3 (Japanese Laid-Open Patent Application No. 4-320876) placing the material being printed in intimate contact against the surface of the gravure printing plate on which the recessions are formed; injecting a photosetting ink into the recessions so that the spaces enclosed by the recessions and the material being printed become filled with ink; then setting the ink within the recessions via the irradiation of light containing the ink photosensitivity wavelength from the back side of the material being printed. When the gravure printing plate is subsequently peeled away from the material being printed, only the set ink remains on the material being printed.

However, problems have arisen in the prior art discussed above, and some of these are discussed below.

One problem is that since the ink splits during ink acceptance; i.e., pickup by the blanket of the RGB ink filling the recessions of the gravure printing plate, not all of the ink is accepted on the blanket and some of the ink remains in the recessions. As more substrates are processed, the remaining ink accumulates and can become a source of contamination. Since this contaminant matter is deposited on the RGB pattern, display irregularities or specks, residual images, or other display defects caused by elution of contaminant matter are observed when the color liquid crystal display is evaluated for reliability.

Moreover, due to the splitting of the ink within the recessions, the ink picked up onto the blanket has a stringy and rough surface. Therefore, when the color filter is applied in a liquid crystal display panel, the problem of disclination or another liquid crystal alignment abnormality can readily occur.

Furthermore, since the ink splits within the recessions and is not 100% accepted onto the blanket, it becomes difficult to control thickness of the RGB film transferred onto the transparent substrate. A resultant problem is that film thickness of the color filter tends to vary, and color reproduction in the display surface can be poor.

In the prior art disclosed in patent document 1, the gravure printing plate is composed of silicone rubber material; therefore, the surface of the gravure printing plate can become scratched by the blade used when filling the recessions with ink-, necessitating frequent replacement of the gravure printing plate. Also, since the ink is transferred directly from the gravure printing plate onto the transparent substrate, a drawback arises that the 3transferred ink pattern has poor dimensional accuracy. Specifically, when the gravure printing plate having recessions filled with ink is directly pressed against the glass substrate for ink to be transferred thereto, the upper portions of the recessions (in proximity to the opening) become splayed by the pressing force, making it difficult to control the width of the transferred ink.

Splitting of the ink during ink transfer can be prevented and the accuracy of the ink pattern improved in the prior art disclosed in patent document 2 or 3 in the same manner as in the present invention. This is achieved by filling the recessions of the gravure printing plate with photosensitive ink and then exposing the ink for curing. In the present invention, however, the accuracy of the ink pattern is improved even further by accelerating the setting rate via a heat treatment or the like.

### SUMMARY OF THE INVENTION

It is therefore an object of the present invention to provide a color filter printing method that affords color filter layer patterns of highly accurate shape without transferring contaminant matter to the color filter layer; a color filter printing apparatus; and a color filter substrate.

The color filter printing method in accordance with the present invention includes the steps of filling recessions in a gravure printing plate with a photosetting colored ink; irradiating the gravure printing plate with UV light from a lower surface side thereof, and curing a lower stratum of the colored ink filling the recessions; heating the gravure printing plate while the UV light is being irradiated; accepting onto a blanket the colored ink filling the recessions; and transferring to a transparent substrate the colored ink that has been accepted on the blanket.

The colored ink may have both a photosetting and a thermosetting function, and may be composed of a mixture of photosetting and thermosetting materials. In preferred practice, the molecular weight of the photosetting material is higher than the molecular weight of the thermosetting material.

Irradiation with UV light may be carried out using a mercury lamp or an excimer.

The gravure printing plate may be positioned on a stage having a heating function, and the gravure printing plate may be heated from the lower surface side using this heating function. Hot air may be blown towards the lower surface and/or from the side of the gravure printing plate to heat the gravure printing plate.

The color filter substrate according to the present invention has a color filter printed by the aforementioned methods. The color filter substrate can be suitably used as a liquid crystal panel.

The color filter printing apparatus according to the present invention has a-stage for a gravure printing plate to be positioned thereon; means for filling recessions of the gravure printing plate with photosetting colored ink; means for irradiating the gravure printing plate with UV light from a lower surface side of the stage; means for heating the gravure printing plate; and a blanket for accepting the colored ink filling the recessions and transferring the colored ink onto a transparent substrate positioned on the stage.

The colored ink may have both a photosetting and a thermosetting function, and may be composed of a mixture of photosetting and thermosetting materials. In preferred practice, the molecular weight of the photosetting material is higher than the molecular weight of the thermosetting material.

Irradiation with UV light may be carried out using a mercury lamp or an excimer.

The means for heating the gravure printing plate may be a heating unit provided to the stage. Alternatively, the means for heating the gravure printing plate may a hot air blower unit that blows hot air towards the lower surface and/or from the side of the gravure printing plate.

According to the present invention, since contaminant matter derived from ink does not accumulate in the recessions of the gravure printing plate, no contaminant matter is transferred to the color filter layer, and reliability as a color filter can be improved. Moreover, there is no stringiness on the ink surface during ink transfer, and thus when the color filter is implemented in a liquid crystal display, display quality is improved, without the occurrence of disclination or other such liquid crystal alignment abnormalities. Furthermore, since no ink is left remaining in the recessions of the gravure printing plate, it is easy to control the thickness of the color filter layer, as well as improve the uniformity of layer thickness and color reproduction.

### BRIEF DESCRIPTION OF THE DRAWINGS

FIG. 1 is a schematic diagram illustrating the manufacturing flow of a conventional color filter substrate;

FIG. 2 is a sectional view depicting features of the color filter printing apparatus according to a first embodiment of the present invention;

FIG. 3 is an outline view illustrating the manufacturing flow of the color filter substrate according to the first embodiment of the present invention;

FIG. 4 is a sectional view of the color filter substrate according to the first embodiment of the present invention; and

FIG. 5 is a schematic perspective view showing the color filter printing apparatus according to the first embodiment of the present invention.

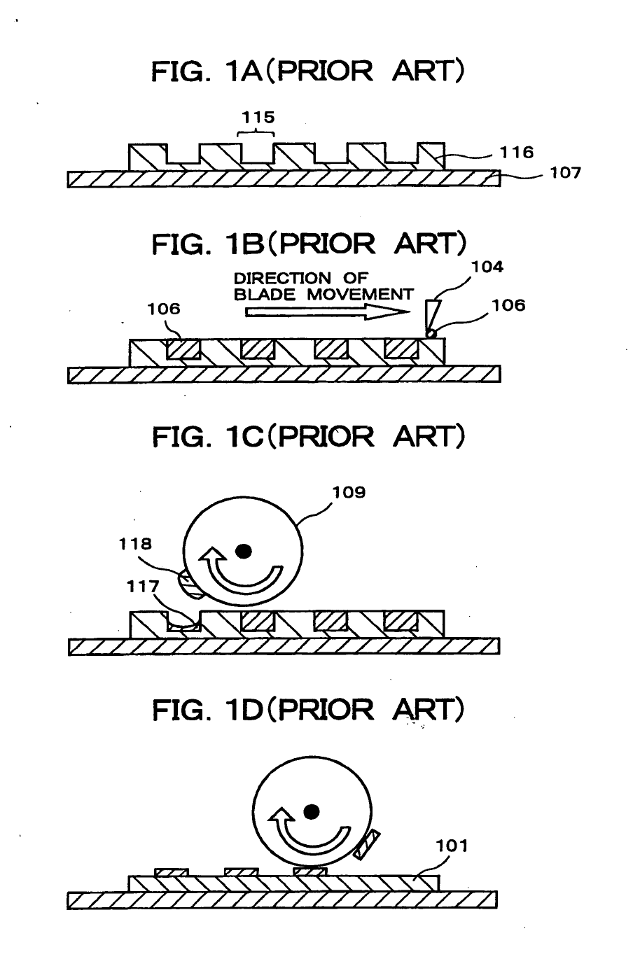

### DESCRIPTION OF THE PREFERRED EMBODIMENTS

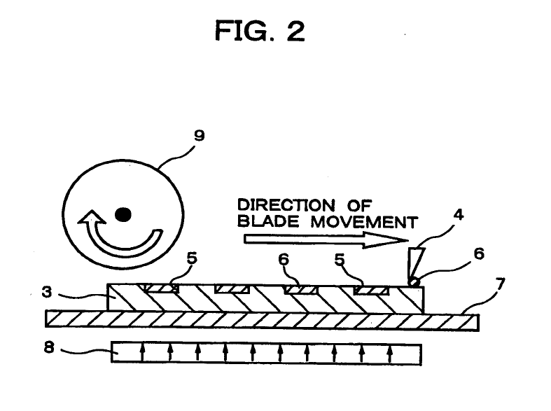

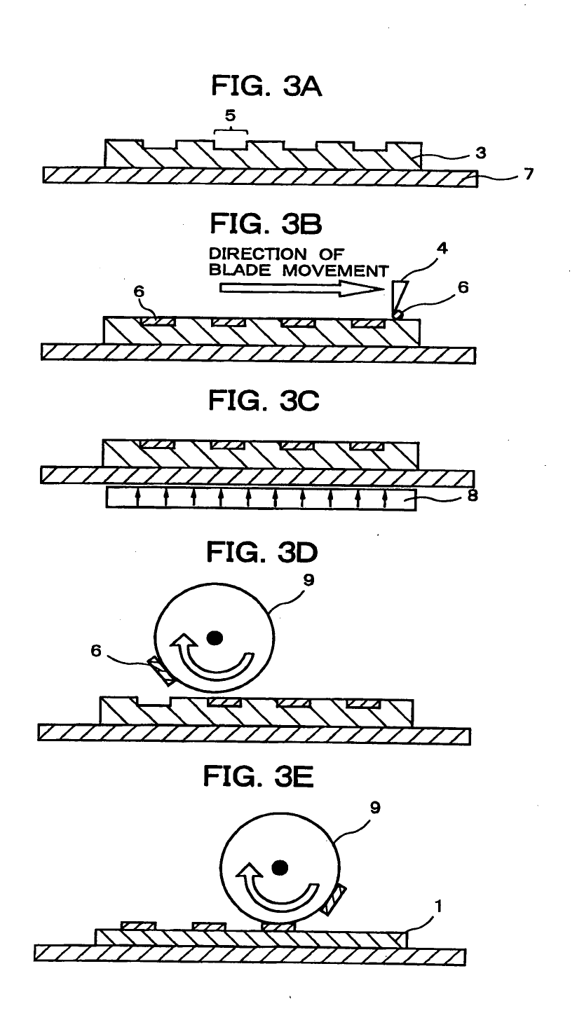

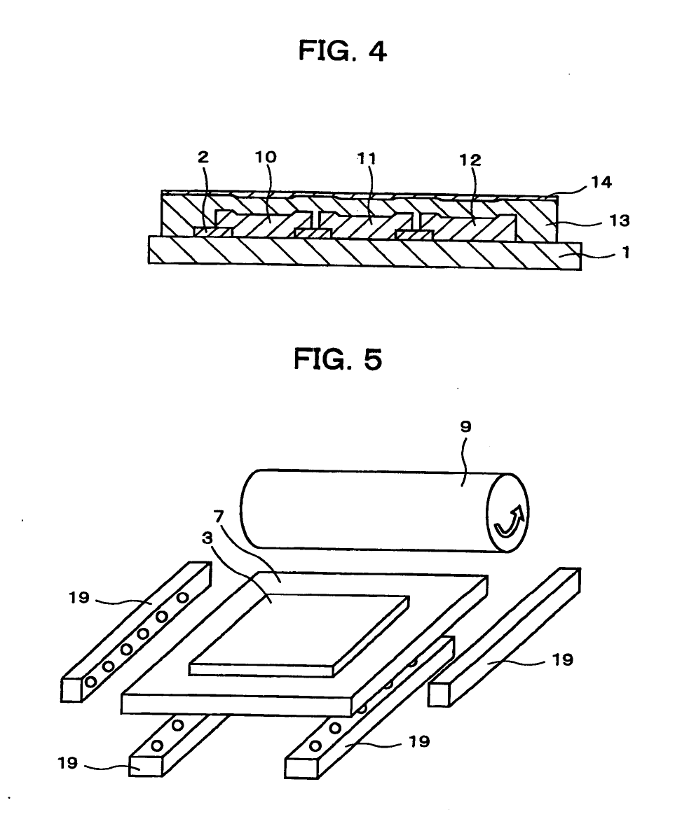

The embodiments of the present invention will be described in detail hereinbelow making reference to the accompanying drawings. First, the color filter printing method, the color filter printing apparatus, and the color filter printing substrate according to the first embodiment of the present invention will be described. FIG. 2 is a sectional view depicting features of the color filter printing apparatus according to the first embodiment of the present invention, and in particular depicts the gravure printing plate and the UV irradiation unit in the color filter substrate manufacturing method. FIG. 3 is an outline view illustrating the manufacturing flow of the color filter substrate according to the present embodiment, wherein FIG. 3A is a sectional view of a gravure printing plate, FIG. 3B is a sectional view of the gravure printing plate filled with colored ink, FIG. 3C is sectional view of the UV irradiation unit, FIG. 3D is a sectional view after a blanket has received the colored ink, and FIG. 3E is a sectional view after transfer of the colored ink to a transparent substrate. FIG. 4 is a sectional view of the color filter substrate according to the present embodiment. FIG. 5 is a schematic perspective view showing the color filter printing apparatus according to the present embodiment.

Following is an overview of the color filter substrate manufacturing method in the present embodiment. First, a black matrix (BM) is formed on a transparent substrate by a photolithographic technique. Next, a color filter layer composed of red, green, and blue is formed by an offset gravure printing process, and then an overcoat (OC) layer for protecting the substrate surface is formed by a spin-coating process. Finally, an indium tin oxide (ITO) film is formed by a sputtering process. One characteristic of the present invention relates to the offset gravure printing process, which is the method used for forming the RGB color filter layer. The above steps will be described sequentially in detail below.

First, the method for forming the black matrix will be described in detail. As shown in FIG. 4, a black matrix 2 is patterned to the desired configuration on a transparent substrate 1 composed of transparent insulating material such as alkali-free glass 0.7 mm thick, for example. This black matrix 2 is necessary to prevent leakage of light and to shield the thin film transistor (TFT) semiconductor layer. The black matrix 2 is formed by applying onto the transparent substrate 1 a negative photosensitive acrylic resist with a light-shielding pigment dispersed therein (e.g., OPTOMER CR SERIES (TM); JSR Corporation), a carbon based resist material, or the like, and then performing exposing/developing steps to form the desired configuration. Film thickness at this time is about 1 to 3 μm. Characteristics required of the black matrix 2 are an optical density (OD) value of 3 or higher, and low film thickness. Next, the black matrix 2 is cured by baking for 60 minutes at 230° C. in a clean oven. In the present embodiment, a so-called resin black matrix based on an organic resin is used; however, the material is not limited thereto, and no problems will be presented when using a black matrix composed of a chromium, double-layer chromium, or other such inorganic film.

Next, the method-for forming the RGB color filter layer which is a feature of the present embodiment will be described. A gravure printing plate 3 is positioned on a stage 7 as shown in FIG. 3A. The gravure printing plate 3 could conceivably be soda lime glass, alkali-free glass, quartz, or the like; in the present embodiment, soda lime glass is used for reasons of cost and operability during filling with colored ink by the blade 4. Recessions 5 corresponding to the RGB color filter pattern layout are formed in the gravure printing plate 3. Where the RGB color filter is a stripe pattern, the recessions 5 are formed only in portions of the gravure printing plate corresponding to the R pattern. By shifting the gravure printing plate in one-pitch increments during printing of the G pattern and the B pattern, color filter patterns of the three colors RGB can be accommodated on a single gravure printing plate. By way of example, the discussion hereinbelow relates to the case where the RGB color filter is a stripe pattern. The method of forming the recessions in the gravure printing plate 3 involves applying an etching resist to the surface, followed by exposure, development, and etching processes to form the recessions 5 at locations corresponding to the desired printing pattern. Here, the etching rate is controlled so that depth of the recessions 5 is of a size commensurate with the RGB color filter thickness (in this case about 2.0 μm) and so that the opening width of the recessions 5 is of size commensurate with the stripe width of the RGB pattern (in this case about 100 μm).

Next, as shown in FIG. 3B, R ink 6 is placed on the end of the gravure printing plate 3. The blade 4 is pressed against the gravure printing plate 3 and swept across the gravure printing plate in a wiping manner, whereby the recessions 5 are filled with the R ink 6. While TEFLON (TM) resin could be used for the blade 4, any other material that can readily fill the recessions with ink while not damaging the gravure printing plate surface would be acceptable as well. A characteristic is that the R ink used here has photosensitive functionality, and is cured through irradiation with UV light. For example, a negative photosensitive ink of red pigment dispersed in acrylic resin could be used.

Next, as shown in FIG. 3C, the gravure printing plate 3 is irradiated with UV light 8 from below the stage 7 on which it rests, causing curing of a lower stratum approximately 2.0 μm thick of the R ink 6 that fills the recessions. The stage 7 on which the gravure printing plate rests is a material transmissive of UV light, for example, glass or the like; UV from a mercury lamp or excimer V, for example, may be used as the UV light. The radiation dose at this time is approximately 1 to 10 mJ for example, which is sufficient to bring about curing of only a lower stratum approximately 2.0 μm thick. When irradiating the gravure printing plate 3 with the UV light 8 from its back face, the rate of curing of the R ink 6 that fills the recessions 5 is accelerated by means of externally heating the gravure printing plate at the same time. Effective means for external heating include: covering the perimeter of the gravure printing plate 3 with a hot bath; providing hot plate functionality to the stage 7 on which the gravure printing plate 3 is placed; or blowing hot air onto the surface of the gravure printing plate 3 immediately after filling the recessions 5 with the R ink 6. For example, heat treatment could be carried out by incorporating a thermocouple, hot water line, or other heating function into the stage 7. In the present embodiment, as depicted in FIG. 5, there is provided a hot air blower unit 19 for blowing hot air towards the surface of the gravure printing plate 3 from the sides of the stage 7. The hot air blower unit 19 could also be positioned to the back side of the stage 7, to heat the gravure printing plate 3 from the back side as well.

Next, as shown in FIG. 3D, a blanket 9 is pressed against the gravure printing plate 3 filled with the R ink 6, the blanket 9 is rotated while the stage 7 on which the gravure printing plate 3 rides is moved, and the R ink 6 filling the recessions 5 is picked up onto the blanket 9. Expressed another way, the blanket accepts the R ink. Here, the extent of contact between the gravure printing plate 3 and the blanket 9; i.e., the width of the nip, is, e.g., 10 mm; and the R ink acceptance speed is, e.g., 20 mm/sec. Since the blanket 9 meshes through a gear (not shown) with the stage 7 carrying the gravure printing plate 3, the R ink acceptance speed and the blanket rotation speed are equal. Any blanket known in the art may be used, though preferably a blanket having a surface of silicone rubber is used.

Next, as shown in FIG. 3E, the transparent substrate 1 is positioned on the stage 7, and the R ink 6 accepted onto the blanket 9 is transferred to the transparent substrate 1. At this time the extent of contact between the blanket 9 and the transparent substrate 1, i.e., the width of the nip, is 10 mm for example; and the R ink transfer speed is 80 mm/sec for example; as in the case of R ink acceptance, the blanket rotation speed is equal to the R ink transfer speed.

FIG. 2 is a sectional view depicting features of the color filter printing apparatus of the present embodiment, and in particular depicts the gravure printing plate and the UV irradiation unit in the color filter substrate manufacturing method. As shown in FIG. 2, the gravure printing plate is positioned on the stage 7, and the recessions 5 formed on the gravure printing plate 3 are filled with ink 6. The ink 6 is photosensitive and is curable through irradiation with UV light. Filling the recessions 5 with the ink 6 is accomplished by putting the ink 6 on the left end of the gravure printing plate 3 in the drawing, pressing the blade 4 against the gravure printing plate 3, and sweeping it in the direction of blade movement over the gravure printing plate. After being filled with the ink 6, the gravure printing plate 3 is irradiated with UV light 8 from below the stage 7 and hot air is blown onto the gravure printing plate 3, which is heated thereby. The lower stratum of the ink 6 in the recessions 5 is accordingly cured. The blanket 9 is subsequently pressed against the gravure printing plate 3, and rotated to accept the ink 6 filling the recessions 5. The ink 6 accepted onto the blanket 9 is then transferred to the transparent substrate 1, whereby the color filter is printed.

An R pattern 10 similar to that shown in FIG. 4 is obtained upon completion of the ink filling step, ink UV irradiation/heating step, ink acceptance step, and ink transfer step described above. A G pattern 11 and a B pattern 12 can be formed by repeating the ink filling through ink transfer steps. The transparent substrate 1 with the RGB pattern formed thereon is baked for 60 minutes at 230° C. in a clean oven to cure the RGB pattern. The order in which the R, G, and B patterns are formed is not limited in any particular way, provided they are formed adjacently in sequential manner.

Next, in the event that the RGB pattern has poor planarity, a thermosetting organic film overcoat 13 composed of acrylic resin or the like is applied to improve planarity (see FIG. 4). At this time the overcoat 13 thickness is in the range of 1.0 μm to 2.0 μm.

Finally, as shown in FIG. 4, a transparent conductive film, for example an ITO film, is formed by sputtering to serve as a counter electrode 14 covering the entire front surface of the transparent substrate 1. Where necessary, patterning is accomplished by photolithography. Film thickness is approximately 150 nm, for example. The color filter substrate of the present invention such as the one depicted in FIG. 4 is manufactured according to the above process.

FIG. 5 is a schematic perspective view showing the color filter printing apparatus according to the present embodiment. In the present embodiment, the gravure printing plate 3 is arranged on the stage 7, and the blanket 9 is positioned over the stage 7, as shown in FIG. 5. A pair of hot air blower units 19 for blowing hot air are disposed to the sides of the stage 7, and a pair of hot air blower units 19 for blowing hot air are disposed below the stage as well. The stage 7 on which the gravure printing plate 3 rests is a material transmissive of UV light, for example, glass or the like; UV from a mercury lamp or excimer, for example, may be used as the UV light.

Next, the effects of the present embodiment will be described. In the present embodiment, after the recessions of the gravure printing plate have been filled with RGB ink, the gravure printing plate is irradiated with UV light from the rear side. Due to the photosensitive function of the RGB ink filling the recessions, the ink gradually begins to cure starting from the bottom of the recessions (the side closer to the UV light). Subsequently, once accepted onto the blanket, the RGB ink will have aggregated into a single entity and not readily split. A heat treatment is simultaneously carried out as UV irradiation is performed, with the hot air blower units blowing hot air onto, and thereby heating, the gravure printing plate. The curing rate of the RGB ink filling the recessions, and the proportion of RGB ink accepted onto the blanket can thus be increased. Accordingly, the RGB ink filling the recessions of the gravure printing plate is completely (100%) accepted onto the blanket. Thus, since contaminant material caused by the ink does not accumulate in the recessions of the gravure printing plate, none is transferred to the RGB color filter layer, and the color filter reliability can be improved. Moreover, the RGB ink surface exhibits no stringiness during ink transfer. Therefore, when the color filter is implemented in a liquid crystal display, display quality is improved, and no disclination or other such liquid crystal alignment abnormalities occur. Furthermore, since no ink is left in the recessions of the gravure printing plate, the thickness of the color filter layer can be readily controlled, layer thickness can have a higher degree of uniformity, and color reproduction can be improved. Furthermore, since glass is used as the material for the gravure printing plate, the surface of the gravure printing plate resists damage due to sweeping of the blade, reducing the number of times that the gravure printing plate must be replaced due to surface wear. Since the ink is transferred to the glass substrate via the blanket, the dimensional accuracy of the transferred ink pattern is adversely affected to a lesser degree than with the prior art disclosed in patent document 1.

Next, a second embodiment of the present invention will be described. A feature of the present embodiment is the use of an ink that has both photosetting and thermosetting properties, and contains a mixture of photosensitive and thermosetting resins. The RGB ink has been imparted with a photosensitive functionality, so that ink splitting will not occur when the ink is accepted onto the blanket, and a thermosetting functionality, for forming the RGB pattern.

When the molecular weight of the photosensitive resin is greater than the molecular weight of thermosetting resin, the photosensitive resin in the RGB ink filling the recessions will tend to collect at the bottom of the recessions while the thermosetting resin will tend to come together at the top, whereby the RGB ink will tend to separate into two strata. Thus, the UV light irradiated from the back surface of the gravure printing plate can contribute efficiently. For example, it is useful for the molecular weight of the photosensitive resin to be from 100,000 to 200,000 and the molecular weight of the thermosetting resin to be from 10,000 to 20,000; i.e., for the ratio of photosensitive resin molecular weight/thermosetting resin molecular weight to be 5 or greater. Moreover, the RGB ink contains a thermosetting resin; therefore, once the RGB ink has been transferred to the transparent substrate, the RGB ink can be quickly cured through thermosetting, and the RGB ink can be anchored on the transparent substrate. The configuration, operation, and effects of the present embodiment are otherwise the same as those of the first embodiment.

The color filter substrate fabricated in accordance with the present invention can be used favorably as a color liquid crystal display panel, for example. This color filter substrate will constitute the color liquid crystal display panel, and is not limited as to liquid crystal drive system or TFT structure.

What is claimed is:

1. A color filter printing method, comprising the steps of:
filling recessions in a gravure printing plate with a photosetting colored ink;
irradiating said gravure printing plate with UV light from a lower surface side thereof, and curing a lower stratum of said colored ink filling said recessions;
heating said gravure printing plate while the UV light is being irradiated;
accepting onto a blanket said colored ink filling said recessions; and
transferring to a transparent substrate said colored ink that has been accepted on said blanket.

2. The color filter printing method according to claim 1, wherein said colored ink has both a photosetting and a thermosetting function, and is composed of a mixture of photosetting and thermosetting materials.

3. The color filter printing method according to claim 2, wherein the molecular weight of said photosetting material is greater than the molecular weight of said thermosetting material.

4. The color filter printing method according to claim 1, wherein irradiation with UV light is carried out using a mercury lamp or an excimer.

5. The color filter printing method according to claim 1, wherein said gravure printing plate is positioned on a stage having heating function, and this heating function is used to heat said gravure printing plate from the lower surface side.

6. The color filter printing method according to claim 1, wherein hot air is blown towards the lower surface and/or from the side of said gravure printing plate, whereby said gravure printing plate is heated.

7. A color filter substrate on which a color filter has been printed by the method according to claim 1.

8. The color filter substrate according to claim 7 wherein the color filter substrate is used as a liquid crystal panel.

9. A color filter printing apparatus, comprising:
a stage for a gravure printing plate to be positioned thereon;
means for filling recessions of the gravure printing plate with photosetting colored ink;
means for irradiating said gravure printing plate with UV light from a lower surface side of said stage;
means for heating said gravure printing plate; and
a blanket for accepting said colored ink filling said recessions and transferring said colored ink onto a transparent substrate positioned on said stage.

10. The color filter printing apparatus according to claim 9, wherein said colored ink has both a photosetting and a thermosetting function, and is composed of a mixture of photosetting and thermosetting materials.

11. The color filter printing apparatus according to claim 10, wherein the molecular weight of said photosetting material is greater than the molecular weight of said thermosetting material.

12. The color filter printing apparatus according to claim 9, wherein irradiation with UV light is carried out using a mercury lamp or an excimer.

13. The color filter printing apparatus according to claim 9, wherein the means for heating said gravure printing plate is a heating unit provided to said stage.

14. The color filter printing apparatus according to claim 9, wherein the means for heating said gravure printing plate is a hot air blower unit that blows hot air towards the lower surface and/or from the side of said gravure printing plate.
